(19) United States
(12) Patent Application Publication
(10) Pub. No.: US 2012/0021211 A1
(43) Pub. Date: Jan. 26, 2012

(54) LAMINATED SHEET FOR BURNING HAVING MARKING PART

(75) Inventors: Shoi Nozaki, Osaka (JP); Hideo Yamamoto, Osaka (JP); Kenji Takehisa, Osaka (JP)

(73) Assignee: YUSHI-SEIHIN CO., LTD., Osaka-shi (JP)

(21) Appl. No.: 13/138,211

(22) PCT Filed: Dec. 22, 2009
(86) PCT No.: PCT/JP2009/071308

§ 371 Date: Jul. 20, 2011

(30) Foreign Application Priority Data
Jan. 23, 2009 (JP) 2009-013519

(51) Int. Cl. B32B 3/00; B29C 71/02

(52) U.S. Cl. 428/337; 156/713

(57) ABSTRACT

A primary object of the present invention is to provide a laminated sheet for firing having an identification part, the sheet being directly attachable to an adherend, having excellent heat resistance, being free from cracks, etc., during rapid temperature changes such as a rapid temperature increase and rapid water-cooling, and being flexible to follow the change in shape of the adherend. The laminated sheet for firing of the present invention comprises a protective sheet, a temporary adhesion layer, a heat-resistant base layer, a combustible adhesive layer, and a release sheet, which are laminated in this order; the heat-resistant base layer having a thickness of 30 μm or less, comprising a silicone resin and an inorganic powder, and having the identification part, the identification part being formed from a heat-resistant ink containing an inorganic pigment.

### TECHNICAL FIELD

The present invention relates to a laminated sheet for firing having an identification part, and a method for producing an adherend to which a label having an identification part is attached.

### BACKGROUND ART

In various industrial fields, such as the food, machinery, and chemistry fields, a sheet having an identification part, on which symbols, letters, patterns, etc., have been printed, is attached to products or their packaging materials to control the production process. A typical example of such process control is a system utilizing labels on which a bar code is printed. In a bar code control system, data such as production conditions, production managers, production period, destination, and product price are read from the bar code label by a bar code reader to control production, sales, and distribution.

Recently, such bar code control systems are being used for process control and quality control in heat treatment, firing process, or the like of iron and steel materials, aluminum and other nonferrous materials, machine tool parts, electronic components, glassware, ceramic products, pottery, etc. In such fields, high heat resistance is required for bar codes to be attached to adherends. Depending on the application, they are required to have, in addition to high heat resistance, tolerance against rapid temperature changes such as rapid temperature rise and cooling in water after high-temperature firing (rapid water-cooling).

For example, a bar code label in which a bar code made of a vitreous material is formed on ceramics, pottery, or enamel is known as a bar code having high heat resistance (see, for example, Patent Document 1). The bar code label disclosed in Patent Document 1 has excellent heat resistance; however, it is necessary to use a stopper such as a screw, or an adhesive, etc., to fix the bar code label of Patent Document 1 to an adherend because the bar code is formed on a plate made of ceramics, pottery, or enamel. Thus, the bar code label cannot be directly attached to an adherend, making the working process complicated.

Another known bar code having high heat resistance is, for example, a label material for firing comprising a supporting member, an adhesive layer, an ink-receiving layer comprising an inorganic compound and a glass frit, and a pattern formed with an ink comprising an inorganic compound, which is different from the inorganic compound in the ink-receiving layer, and a glass frit (see, for example, Patent Document 2). However, because of the glass frits contained in the ink-receiving layer and the ink for forming a pattern, the label material of Patent Document 2 may suffer from cracks when it undergoes rapid temperature changes (particularly, rapid water-cooling).

In addition, a label comprising an adhesive layer, a label base material in a sheet form composed of an inorganic powder and a silicone-based resin, and a pattern is known (see, for example, Patent Document 3). However, the label of Patent Document 3 may suffer from thermal expansion and strain due to curing when it undergoes a rapid temperature increase.

Furthermore, since the labels of Patent Documents 2 and 3 do not use a protective sheet, the ink-receiving layer and the label base material are required to be thick in order to retain the shape of the labels. Therefore, these labels are not sufficiently flexible to follow the change in shape of adherends.

### CITATION LIST

### Patent Literature

PTL 1: U.S. Pat. No. 4,775,786
PTL 2: Japanese Examined Patent Publication No. H07-45258
PTL 3: Japanese Unexamined Patent Publication No. H06-175585

### SUMMARY OF INVENTION

### Technical Problem

A primary object of the present invention is to provide a laminated sheet for firing having an identification part, the sheet being directly attachable to an adherend, having excellent heat resistance, being free from cracks, etc., during rapid temperature changes such as a rapid temperature increase and rapid water-cooling, and being flexible to follow the change in shape of the adherend.

### Solution to Problem

As a result of extensive research, the present inventors found that the above object can be achieved by laminating a protective sheet, a temporary adhesion layer, a heat-resistant base layer, a combustible adhesive layer, and a release sheet in this order to form a laminated sheet; wherein the heat-resistant base layer has a thickness of 30 μm or less, comprises a silicone resin and an inorganic powder, and has an identification part, the identification part being formed of a heat-resistant ink containing an inorganic pigment. The present invention has been accomplished upon further study based on these findings.

More specifically, the present invention provides the following:

Item 1. A laminated sheet for firing having an identification part, the laminated sheet comprising a protective sheet, a temporary adhesion layer, a heat-resistant base layer, a combustible adhesive layer, and a release sheet, which are laminated in this order;

the heat-resistant base layer having a thickness of 30 μm or less, comprising a silicone resin and an inorganic powder, and having the identification part, the identification part being formed from a heat-resistant ink containing an inorganic pigment.

Item 2. The laminated sheet for firing according to Item 1, wherein the heat-resistant base layer further comprises a polymetallocarbosilane resin and/or a glass frit.
Item 3. The laminated sheet for firing according to Item 1 or 2, wherein the heat-resistant ink further comprises at least one member selected from the group consisting of a silicone resin, a polymetallocarbosilane resin, and a glass frit.
Item 4. A method for producing an adherend to which a label having an identification part is attached, the method comprising the steps of:

(1) removing the release sheet from the laminated sheet for firing having an identification part according to claim 1, and attaching, to an adherend, the laminated sheet for firing from which the release sheet has been removed;

(2) removing the protective sheet and the temporary adhesion layer from the laminated sheet for firing, from which the release sheet has been removed and which has been attached to the adherend; and

(3) firing the adherend having the heat-resistant base layer and combustible adhesive layer.

Item 5. The method according to Item 4, wherein the adherend is a substrate selected from the group consisting of a metal substrate, a glass substrate, and a ceramic substrate.

### Advantageous Effects of Invention

The present invention can provide a laminated sheet for firing having an identification part, which can be directly attached to an adherend, has excellent heat resistance, is free from cracks, etc., during rapid temperature changes such as a rapid temperature increase and rapid water-cooling, and is flexible to follow the change in shape of the adherend. The present invention can also provide a method for producing an adherend to which a label having an identification part is attached, using the laminated sheet for firing of the present invention.

### BRIEF DESCRIPTION OF DRAWINGS

FIG. 1 is a schematic diagram of the laminated sheet for firing having an identification part according to the present invention.

FIG. 2 shows one embodiment of the method for producing the laminated sheet for firing of the invention.

FIG. 3 shows another embodiment of the method for producing the laminated sheet for firing of the invention.

### DESCRIPTION OF EMBODIMENTS

### 1. Laminated Sheet for Firing Having Identification Part

The laminated sheet for firing having an identification part according to the present invention (hereinafter also simply referred to as “the laminated sheet for firing of the present invention”) comprises a protective sheet, a temporary adhesion layer, a heat-resistant base layer, a combustible adhesive layer, and a release sheet, which are laminated in this order; the heat-resistant base layer having a thickness of 30 μm or less, comprising a silicone resin and an inorganic powder, and having the identification part, the identification part being formed from a heat-resistant ink comprising an inorganic pigment.

Each component of the laminated sheet for firing of the present invention is described in detail below.

1.1 Protective Sheet

The protective sheet is intended to maintain the form of the laminated sheet for firing of the present invention, and is to be peeled off after the laminated sheet for firing of the present invention is attached to an adherend.

The thickness of the protective sheet is not limited as long as the form of the laminated sheet for firing of the present invention can be maintained; however, it is preferably 0.1 to 500 μm, and more preferably 10 to 250 μm. When the thickness of the protective sheet is less than this range, excellent printing cannot be provided on the temporary adhesive surface of the protective sheet, and tears and creases tend to be generated when the protective sheet is attached. When the thickness is more than this range, the laminated sheet becomes inflexible; such a sheet is difficult to attach, and cannot follow the substrate form. Additionally, removal of bubbles tends to be difficult.

The protective sheet is not limited, and sheets made from various materials can be used. For example, transfer paper, PET sheet, paper sheet, nonwoven fabric, etc., can be used.

1.2 Temporary Adhesion Layer

The temporary adhesion layer is intended to temporarily bond the heat-resistant base layer and the protective sheet, and is to be peeled off after the laminated sheet for firing of the present invention is attached to an adherend.

The thickness of the temporary adhesion layer is preferably, but not limited to, 0.1 to 100 μm, and more preferably 5 to 20 μm. When the thickness of the temporary adhesion layer is less than this range, the protective sheet tends not to be easily removed off after the laminated sheet is attached to a substrate.

The temporary adhesion layer is not limited, as long as it can temporarily bond the heat-resistant base layer and the protective sheet; for example, water-soluble resins, light adhesives, etc., can be used. A temporary adhesion layer made from water-soluble resins or a temporary adhesion layer made from light adhesives is preferable because the temporary adhesion layer made from water-soluble resins can be easily dissolved upon contact with water and thereby peeled off, and the temporary adhesion layer made from light adhesives can be removed by peeling as is, together with the protective sheet.

Examples of water-soluble resins include dextrin, starch, polyvinyl alcohol, polyethylene oxide, polyacrylic acid salt, etc., which can be used singly or in combination. Among these, dextrin is preferred in terms of ease of peeling.

Examples of light adhesives include acrylic resin, acrylic emulsion, polyester resin, and other resins, to which isocyanate etc. can be added as cross-linking agents. When a cross-linking agent is added, the amount thereof is not limited, and can be suitably determined; however, it is generally about 30 parts by weight or less, and preferably about 0.1 to 10 parts by weight, based on 100 parts by weight of the resin.

1.3 Heat-Resistant Base Layer

The heat-resistant base layer is formed from a base layer coating solution comprising a silicone resin and an inorganic powder, and has an identification part composed of a heat-resistant ink having an inorganic pigment.

(1) Base Layer Coating Solution

The base layer coating solution contains a silicone resin and an inorganic powder, and may optionally contain polymetallocarbosilane resins, glass frits, (e.g., glass frits of borosilicate glass or soda glass), organic solvents, dispersants, surface modifiers, viscosity modifiers, and the like.

(1-1) Silicone Resin

In the invention, the silicone resin is a compound having a polyorganosiloxane structure in its molecule. Examples of silicone resins include straight silicone resins, modified silicone resins, etc., which can be used singly or in combination.

The weight-average molecular weight of the silicone resin is generally 500 to 5,000,000, and preferably 700 to 1,000,000.

An example of straight silicone resins is an organopolysiloxane having a hydrocarbon group as a main organic group. The organopolysiloxane may have a hydroxyl group. Examples of hydrocarbon groups include aliphatic hydrocarbon groups and aromatic hydrocarbon groups. Among these, C₁-C₆ aliphatic hydrocarbon groups and C₆-C₁₂ aromatic hydrocarbon groups are preferred. These hydrocarbon groups may be used singly or in combination.

Examples of C₁-C₆ aliphatic hydrocarbon groups include methyl, ethyl, propyl, butyl, pentyl, vinyl, allyl, propenyl, butenyl, and pentenyl groups. Examples of C₆-C₁₂ aromatic hydrocarbon groups include phenyl, methylphenyl, ethylphenyl, butylphenyl, tertiary butylphenyl, naphthyl, styryl, allylphenyl, and propenylphenyl groups.

The straight silicone resin can be produced, for example, by hydrolytic condensation of one or more silane compounds, such as chlorosilane or alkoxysilane compounds comprising the aforementioned aliphatic hydrocarbon groups or aromatic hydrocarbon groups; or by hydrolytic co-condensation of a mixture of the above silane compounds with tetrachlorosilane or tetraalkoxysilane.

Examples of chlorosilane compounds include methyltrichlorosilane, dimethyldichlorosilane, trimethylchlorosilane, methylethyldichlorosilane, vinylmethyldichlorosilane, vinyltrichlorosilane, phenyltrichlorosilane, diphenyldichlorosilane, methylphenyldichlorosilane, vinylphenyldichlorosilane, etc.

Examples of alkoxysilane compounds include methyltrimethoxysilane, dimethyldimethoxysilane, dimethyldiethoxysilane, trimethylmethoxysilane, vinylmethyldimethoxysilane, vinyltributoxysilane, phenyltriethoxysilane, diphenyldimethoxysilane, methylphenyldipropoxysilane, vinylphenyldimethoxysilane, etc.

The modified silicone resin is an organopolysiloxane having an organic group other than a hydrocarbon group. Examples of the modified silicone resin include methoxy-containing silicone resins, ethoxy-containing silicone resins, epoxy-containing silicone resins, alkyd resin-modified silicone resins, acrylic resin-modified silicone resins, polyester resin-modified silicone resins, epoxy resin-modified silicone resins, etc.

These modified silicone resins can be produced, for example, by reaction of the hydroxyl group of a straight silicone resin with an organic compound having a functional group reactive with the hydroxyl group, such as carboxyl, acid anhydride, hydroxyl, aldehyde, epoxy, and chloride groups; by copolymerization of a straight silicone resin containing an unsaturated hydrocarbon group, such as a vinyl group, with a compound having an unsaturated double bond; or by hydrolytic condensation or hydrolytic co-condensation of a modified silane compound obtained by the reaction of the aforementioned silane compounds with other organic compounds. The organic compounds to be reacted may be low-molecular-weight compounds, or high-molecular-weight compounds such as resin.

The amount of silicone resin added is preferably 5 to 90% by weight, and more preferably 10 to 80% by weight, based on the total solids content of the base layer coating solution in terms of coloration and base layer formation.

In the present invention, the above silicone resins can be used singly or in combination; however, it is preferable to use a polymetallocarbosilane resin, described below, in combination, in terms of heat resistance performance under high-temperature exposure conditions (900° C.).

(1-2) Polymetallocarbosilane Resin

The polymetallocarbosilane resin is a resin having a crosslinked structure obtained, for example, by reacting polycarbosilane with metal alkoxide.

Examples of metal include titanium, zirconium, molybdenum, chromium, etc.; among these, titanium and zirconium are preferably used.

Preferred examples of the polymetallocarbosilane resin are polytitanocarbosilane resins, polyzirconocarbosilane resins, etc.

In order to improve its coating properties, the polymetallocarbosilane resin is preferably mixed with a solvent, such as toluene, xylene, etc.

Specific examples of the polytitanocarbosilane resin or a mixture comprising the polytitanocarbosilane resin include a “Tyranno Coat™ VS-100”, “Tyranno Coat™ VN-100”, etc., manufactured by Ube Industries, Ltd.

The weight-average molecular weight of the polymetallocarbosilane resin is preferably 500 to 10,000, and more preferably 700 to 3,000.

The amount of polymetallocarbosilane resin added is preferably, but not limited to, 10 to 900 parts by weight, and more preferably 25 to 400 parts by weight, based on 100 parts by weight of silicone resin. The use of polymetallocarbosilane resin in an amount within this range is preferable because film-forming properties, heat resistance, and heat-shock resistance can be simultaneously satisfied.

(1-3) Inorganic Powder

An inorganic pigment is preferably used as the inorganic powder, although not limited thereto. Examples thereof include white substances, such as silica, titanium dioxide, alumina, zirconia, mica, calcium oxide, zinc sulfide-barium sulfate (lithopone), talc, clay, kaolin, and calcium carbonate; metal compounds, such as carbonates, nitrates, and sulfates, which are oxidized to form such white substances in a heat treatment; reddish-brown substances containing metal ions, such as iron, copper, gold, chromium, selenium, zinc, manganese, aluminum, and tin (e.g., zinc oxide-iron oxide-chromium oxide, manganese oxide-alumina, chromium oxide-tin oxide, and iron oxide); blue substances containing metal ions, such as manganese, chromium, aluminum, cobalt, copper, iron, zirconia, and vanadium (e.g., cobalt oxide-aluminum oxide, cobalt oxide-aluminum oxide-chromium oxide, cobalt oxide, zirconia-vanadium oxide, and chromium oxide-divanadium pentoxide); black substances containing metal ions, such as iron, copper, manganese, chromium, cobalt, and aluminum (e.g., copper oxide-chromium oxide-manganese oxide, chromium oxide-manganese oxide-iron oxide, chromium oxide-cobalt oxide-iron oxide-manganese oxide, chromate, and permanganate); yellow substances containing metal ions, such as vanadium, zinc, tin, zirconium, chromium, titanium, antimony, nickel, praseodymium, and vanadium (e.g., titanium oxide-antimony oxide-nickel oxide, titanium oxide-antimony oxide-chromium oxide, zinc oxide-iron oxide, zirconium-silicon-praseodymium, vanadium-tin, and chromium-titanium-antimony); green substances containing metal ions, such as chromium, aluminum, cobalt, calcium, nickel, and zinc (e.g., titanium oxide-zinc oxide-cobalt oxide-nickel oxide, cobalt oxide-aluminum oxide-chromium oxide-titanium oxide, chromium oxide, cobalt-chromium, and alumina-chromium); and pink substances containing metal ions, such as iron, silicon, zirconium, aluminum, and manganese (e.g., aluminum-manganese and iron-silicon-zirconium). Although these can be used singly or in combination, alumina or titanium oxide is particularly preferred.

In order to form an identification part, described later, the heat-resistant base layer is required to develop a color different from that of a heat-resistant ink, described later, which forms the identification part. That is, the inorganic pigment contained in the heat-resistant base layer is preferably different from the inorganic pigment contained in the heat-resistant ink. Examples of such combinations are as follows: the inorganic pigment contained in the heat-resistant base layer is white titanium oxide, and the inorganic pigment contained in the heat-resistant ink is a black firing pigment composed of copper oxide, chromium oxide, and manganese oxide; and

the inorganic pigment contained in the heat-resistant base layer is a black firing pigment composed of copper oxide, chromium oxide, and manganese oxide, and the inorganic pigment contained in the heat-resistant ink is white titanium oxide.

The average particle diameter of the inorganic powder is preferably, but not limited to, 0.01 to 200 μm, and more preferably 0.1 to 100 μm. The form of the inorganic powder is not limited; for example, spherical, fibrous, and scaly powders can be used. Examples of the inorganic powder usable in the present invention include inorganic powders having a high aspect ratio, such as single-crystal inorganic fibers.

The amount of inorganic powder added is preferably 20 to 80% by weight, and more preferably 30 to 70% by weight, based on the total solids content of the base layer coating solution. The use of inorganic powder in an amount within this range is preferable because excellent coloration and hiding properties can be achieved.

(1-4) Other Additives

Examples of glass frits include a glass frit or powder silicate having a melting point of 900° C. or less, metal oxide mixed powder that is softened and vitrified at a temperature of 900° C. or less, etc., and those having a mean particle diameter of 0.1 to 100 μm, and preferably 0.2 to 50 μm, can be used.

The amount of glass frit, when added, is preferably 60% by weight or less, more preferably 0.1 to 40% by weight, even more preferably 0.1 to 10% by weight, and still even more preferably 0.1 to 5% by weight, based on the total solids content of the base layer coating solution. An amount of glass frit more than 60% by weight is not preferable because cracks are formed during hot-cold cycling or rapid cooling.

Examples of organic solvents include aliphatic hydrocarbons such as hexane, octane, decane, and cyclohexane; aromatic hydrocarbons such as benzene, toluene, xylene, cumene, and naphthalene; ketones such as acetone, methyl ethyl ketone, and cyclohexanone; alcohols such as methanol, ethanol, and 2-ethylhexanol; ethers such as ethylene glycol monomethyl ether and diethylene glycol dibutyl ether; esters such as methyl acetate, ethyl formate, and ethyl acetoacetate; petroleum distillation fractions such as gasoline, kerosene, and gas oil; and the like. The amount of organic solvent used is not limited, and may be within a range that facilitates the handling of the base layer coating solution. Moreover, water can also be used as a solvent.

Examples of dispersants include aliphatic polyvalent carboxylic acids, amine salts of polyester acids, long-chain amine salts of polycarboxylic acids, amine salts of polyether ester acids, amine salts of polyether phosphate esters, polyether phosphate esters, amide amine salts of polyester acids, etc.

Although the amount of dispersant added is not limited, and can be suitably determined depending on the composition of the base layer coating solution, it is preferably 10% by weight or less, more preferably 0 to 5% by weight, and even more preferably 0.1 to 5% by weight, based on the total solids content of the base layer coating solution. The use of dispersant in an amount within this range is preferable because excellent fluidity can be achieved in the preparation and application processes of the coating solution.

(2) Identification Part

The identification part is composed of a heat-resistant ink containing an inorganic pigment, and known heat-resistant inks used in the art can be used.

Examples of inorganic pigments include carbon; oxides of metals such as iron, cobalt, nickel, chromium, copper, manganese, titanium, and aluminum; and the like. These can be used singly or in combination. Among these, metal oxides are preferred in terms of heat resistance.

The metal oxide is supplied in the form of a powder that generally has a mean particle diameter of 0.01 to 50 μm, and preferably 0.1 to 10 μm.

The amount of inorganic pigment added is preferably 10 to 90% by weight, and more preferably 20 to 80% by weight, based on the total solids content of the heat-resistant ink. The use of inorganic pigment in an amount within this range is preferable because coloration and film-forming properties can be simultaneously satisfied.

In addition to the inorganic pigments described above, the heat-resistant ink can further contain binders, glass frits (e.g., glass frits of borosilicate glass or soda glass), dispersants, surface modifiers, and viscosity modifiers.

Examples of binders include resins, waxes, fats and oils, etc.

Examples of resins include silicone resins, hydrocarbon resins, vinyl resins, acetal resins, imido resins, amide resins, acrylic resins, polyester resins, polyurethane resins, alkyd resins, protein resins, cellulose resins, etc. For example, organopolysiloxane, polymetallocarbosilane, polystyrene, polyethylene, polypropylene, polyvinyl acetate, polyvinyl butyral, polyvinyl formal, polyimide, polyamide, poly(meth)acrylic acid ester, gelatin, cellulose derivatives, polyvinyl alcohol, polyvinyl pyrrolidone, etc., can be used. These can be used singly, or as mixtures or copolymers thereof.

Examples of waxes include paraffin waxes, natural waxes, higher alcohol waxes, higher amide waxes, higher fatty acids, ester waxes, etc. For example, paraffin wax, polyethylene wax, beeswax, carnauba wax, stearyl alcohol, palmityl alcohol, oleyl alcohol, stearamide, oleamide, palmitamide, ethylenebisstearamide, stearic acid, oleic acid, palmitic acid, myristic acid, ethyl stearate, butyl palmitate, palmityl stearate, stearyl stearate, etc., can be used.

Examples of fats and oils include castor oil, soybean oil, linseed oil, olive oil, beef tallow, lard, mineral oils, etc.

Examples of glass frits include glass frits or powder silicate having a melting point of 900° C. or lower, metal oxide mixed powder that is softened and vitrified at a temperature of 900° C. or less, etc.; specifically, a glass frit having a particle size of 0.1 to 100 μm, preferably 0.2 to 50 μm, can be used.

Examples of solvents to be used for dispersion or kneading include aliphatic hydrocarbons such as hexane, octane, decane, and cyclohexane; aromatic hydrocarbons such as benzene, toluene, xylene, cumene, and naphthalene; ketones such as acetone, methyl ethyl ketone, and cyclohexanone; alcohols such as methanol, ethanol, and 2-ethylhexanol; ethers such as ethylene glycol monomethyl ether and diethylene glycol dibutyl ether; esters such as methyl acetate, ethyl formate, and ethyl acetoacetate; petroleum distillation fractions such as gasoline, kerosene, and gas oil; water; etc. It is preferable to use such solvents for dilution in an amount of 500 parts by weight or less, preferably 200 parts by weight or less, per 100 parts by weight of the total amount of the inorganic pigment and binder.

The heat-resistant ink containing such an inorganic pigment can be produced, for example, by mixing a binder in an amount of 1 to 1,000 parts by weight, preferably 10 to 200 parts by weight, per 100 parts by weight of the inorganic pigment; adding a solvent as needed; and dispersing or kneading the mixture with a dispersion machine, such as a disper, ball mill, roll mill, sand mill, or the like, giving a liquid-like or paste-like mixture.

Any patterns (identification parts), including characters and symbols such as a bar code, may be formed using the heat-resistant ink composed of such components by known printing methods, laser marking, etc. Examples of printing methods include gravure offset printing, plate offset printing, letterpress printing, intaglio printing, silk screen printing, ink-jet printing, ribbon printing, etc.

The identification part is formed by printing patterns, such as characters or symbols (bar codes, etc.), or images. Labels provided with such identification parts can be used as data carrier labels, typified by bar code labels.

The layer thickness of the heat-resistant base layer having such an identification part is 30 μm or less, preferably 0.1 to 25 μm, and more preferably 0.2 to 20 μm. A thickness of more than 30 μm is not preferable because cracks are formed by rapid heating or rapid water-cooling.

The layer thickness used herein indicates the thickness after the base layer coating solution is applied and dried in the production of the laminated sheet for firing of the present invention. The layer thickness after drying (dry layer thickness) is equal to the thickness of the heat-resistant base layer in the laminated sheet for firing of the present invention.

1.4 Combustible Adhesive Layer

The combustible adhesive layer is a layer intended to attach the laminated sheet for firing of the present invention on an adherend before firing. The combustible adhesive layer is evaporated or decomposed by heat when the adherend, to which the laminated sheet for firing of the present invention is attached, is fired.

The layer thickness of the combustible adhesive layer is preferably, but not limited to, 1 to 100 μm, and more preferably 5 to 60 μm. When the layer thickness of the combustible adhesive layer is less than this range, sufficient adhesion to the substrate is not achieved; whereas when the layer thickness is more than this range, bulges and cracks tend to form.

The layer thickness used herein indicates the thickness after the combustible adhesive is applied and dried in the production of the laminated sheet for firing of the present invention. The layer thickness after drying (dry layer thickness) is equal to the thickness of the combustible adhesive layer in the laminated sheet for firing of the present invention.

The combustible adhesive is not limited, and commercially available adhesives can be used. In general, examples of adhesives include polyolefin-based resins such as polyethylene (e.g., low-density and high-density polyethylenes), polypropylene, polybutene, polyisobutylene, isobutylene maleic anhydride copolymers, polyvinyl acetate, polypropylene chloride, polyvinylidene chloride, and polyvinyl ether; acrylate-based resins such as polymethylmethacrylate, polyacrylic acid, polymethyl acrylate, and polyacrylamide; polyester-based resins such as polyethylene terephthalate, polybutylene terephthalate, polyethylene naphthalate, and polycyclohexane dimethyleneterephthalate; petroleum-based resins such as polycyclopentadiene; silicone-based resins such as straight silicone resins, silicone adhesives, and modified silicone resins; phenol-based resins such as 100% phenol resins, novolak-type phenol resins, and resol-type phenol resins; modified alkyd resins such as rosin-modified alkyd resins, phenol-modified alkyd resins, styrenated alkyd resins, and silicone-modified alkyd resins. Such resins can be used singly or in combination: If necessary, the resins can be dissolved or dispersed in a solvent, and cross-linking agents, adhesion-imparting agents, etc., can be added thereto, as needed.

1.5 Release Sheet

The release sheet is laminated to prevent the combustible adhesive layer from adhering to a substance other than an adherend when the laminated sheet for firing of the present invention is not used. The thickness of the release sheet is not limited, and can be suitably determined.

The release sheet is not limited, and commercially available release sheets can be used. Materials for the release sheet are not limited; for example, glassine paper treated with silicone for release paper or fluorine, polyethylene laminated paper, polyethylene terephthalate (PET) film, biaxially oriented polypropylene (OPP) film, polyethylene (PE) film, PVC sheet, etc., can be used.

### 2. Method for Laminating the Laminated Sheet for Firing of the Present Invention

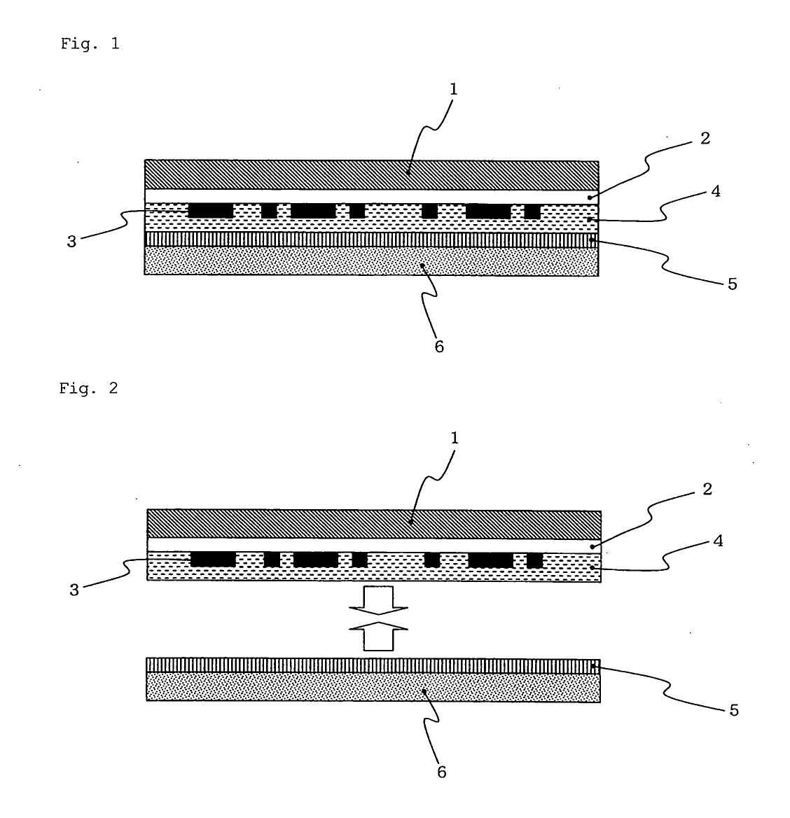

The method for laminating the laminated sheet for firing of the present invention is not particularly limited insofar as the method comprises laminating a protective sheet (1), a temporary adhesion layer (2), a heat-resistant base layer (4) having an identification part (3), a combustible adhesive layer (5), and a release sheet (6) in that order, as shown in FIG. 1.

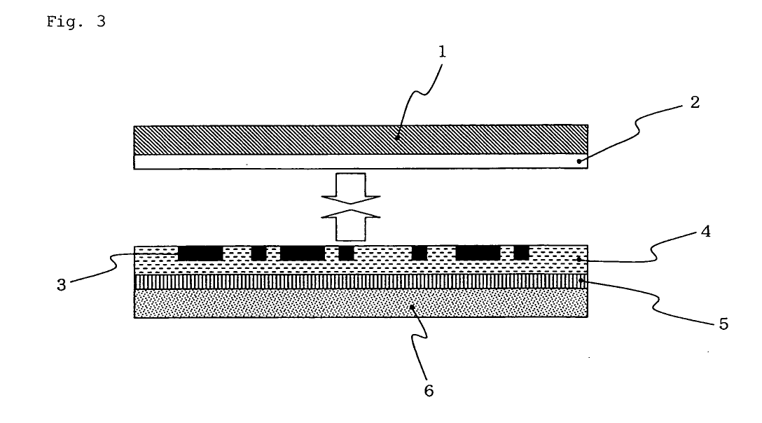

Specific examples of the above methods include a method shown in FIG. 2 in which the two sheets, i.e., the protective sheet (1) comprising the temporary adhesion layer (2) and the heat-resistant base layer (4) having the identification part (3), and the release sheet (6) having the combustible adhesive layer (5) are separately formed in advance, and these sheets are adhered together (hereinafter referred to as “method 1”); and a method shown in FIG. 3 in which the two sheets, i.e., the protective sheet (1) having the temporary adhesion layer (2), and the release sheet (6) comprising the combustible adhesive layer (5) and the heat-resistant base layer (4) having the identification part (3) are separately formed in advance, and these sheets are adhered together (hereinafter referred to as “method 2”).

Methods 1 and 2 are described in detail below.

2.1 Method 1

(1) Production of the Protective Sheet Comprising the Temporary Adhesion Layer and the Heat-Resistant Base Layer

A composition for forming the temporary adhesion layer (2) (hereinafter referred to as “temporary adhesion layer composition”) is applied to the protective sheet (1). The temperature and time to dry the temporary adhesion layer composition can be suitably changed without particular limitation. For example, a hot air circulation oven is used to dry at 40 to 200° C. for about 0.1 to 60 minutes.

The identification part (3) is formed using heat-resistant ink on the temporary adhesion layer (2) of the protective sheet (1) having the temporary adhesion layer (2) formed thereon. The method for forming the identification part (3) is as described above. In method 1, the identification part (3), such as a bar code, must be printed in mirror writing.

Next, a base layer coating solution is applied to the protective sheet (1) to cover the identification part (3) to a dry layer thickness in a desired range, and dried. The temperature and time to dry the base layer coating solution can be suitably changed without particular limitation. For example, a hot air circulation oven is used to dry at 40 to 200° C. for about 0.1 to 60 minutes. In this way, the protective sheet (1) comprising the temporary adhesion layer (2) and the heat-resistant base layer (4) having the identification part (3) is formed.

(2) Production of the Release Sheet Having the Combustible Adhesive Layer

The combustible adhesive layer (5) is formed by applying a combustible adhesive to the release sheet (6) and drying the same. The temperature and time to dry the combustible adhesive can be suitably changed without particular limitation. For example, a hot air circulation oven is used to dry at 50 to 200° C. for about 0.1 to 60 minutes. In this way, the release sheet (6) having the combustible adhesive layer (5) is formed.

(3) Production of the Laminated Sheet for Firing of the Present Invention

The protective sheet formed in (1) above and the release sheet formed in (2) above are adhered together in such a manner that the heat-resistant base layer (4) of the protective sheet and the combustible adhesive layer (5) of the release sheet are fit together.

2.2 Method 2

(1) Production of the Release Sheet Having the Combustible Adhesive Layer and the Heat-Resistant Base Layer

A base layer coating solution is applied to a release slip to a desired dry layer thickness. The temperature and time to dry the base layer coating solution can be suitably changed without particular limitation. For example, a hot air circulation oven is used to dry at 50 to 200° C. for about 0.1 to 60 minutes. The resulting product is regarded as base sheet 1.

Separately, a combustible adhesive is applied to the release sheet (6) to a desired dry layer thickness. The temperature and time to dry the combustible adhesive can be suitably changed without particular limitation. For example, a hot air circulation oven is used to dry at 50 to 200° C. for about 0.1 to 60 minutes. The resulting product is regarded as base sheet 2.

The heat-resistant base layer (4) of the base sheet 1 and the combustible adhesive layer (5) of the base sheet 2 are adhered together, and the release slip on the heat-resistant base layer (4) is removed. Thereby, the release sheet (6) comprising the heat-resistant base layer (4) not having an identification part, and the combustible adhesive layer (5) is formed.

Next, a bar code is printed using a heat-resistant thermal transfer ink sheet that has been formed in advance on the heat-resistant base layer (4) of the thus-obtained release sheet, thereby forming the identification part (3). In this way, the release sheet (6) comprising the combustible adhesive layer (5), and the heat-resistant base layer (4) having the identification part (3) is formed.

(2) Production of the Protective Sheet Having the Temporary Adhesion Layer

The temporary adhesion layer composition is applied to the protective sheet (1) to a desired dry layer thickness. The temperature and time to dry the coating solution can be suitably changed without particular limitation. For example, a hot air circulation oven is used to dry at 50 to 200° C. for about 0.1 to 60 minutes.

(3) Production of the Laminated Sheet for Firing of the Present Invention

The heat-resistant base layer (4) of the release sheet obtained in (1) above and the temporary adhesion layer (2) of the protective sheet obtained in (2) above are adhered together, thereby obtaining a laminated sheet for firing having the identification part (3).

In either method 1 or method 2, any known method can be used as a method for applying the temporary adhesion layer composition, base layer coating solution, and combustible adhesive. Examples of such known methods include printing techniques such as screen printing, roll coater methods, gravure roll coater methods, doctor blade methods, and bar coater methods. The method for forming the identification part using the heat-resistant ink is as described above.

Further, as one embodiment, the laminated sheet for firing can also be formed as follows: the two sheets, i.e., the release sheet comprising the combustible adhesive layer and the heat-resistant base layer not having the identification part, and the protective sheet having the temporary adhesion layer are separately provided in advance as in the above method 2. Then, at the work site, a bar code is printed on the heat-resistant base layer of the release sheet, and the release sheet is adhered to the protective sheet having the temporary adhesion layer for use.

### 3. Method for Producing an Adherend to which a Label Having the Identification Part is Attached

The present invention relates to a method for producing an adherend to which a label having an identification part is attached, the method comprising a step of removing the release sheet from the laminated sheet for firing having an identification part of the present invention; and attaching, to an adherend, the laminated sheet for firing from which the release sheet has been removed (step 1),

a step of removing the protective sheet and the temporary adhesion layer from the laminated sheet for firing, from which the release sheet has been removed and which has been attached to the adherend (step 2), and

a step of firing the adherend having the heat-resistant base layer and combustible adhesive layer (step 3).

Each step is described in detail below.

(1) Step 1

In step 1, the release sheet is removed from the laminated sheet for firing having an identification part of the present invention, and the laminated sheet for firing from which the release sheet has been removed is attached to an adherend.

The adherend is not particularly limited. The size, form, structure, materials, etc., thereof can be suitably selected according to the purpose. Examples of the materials include glass, ceramics, and metals such as SUS and aluminum. Examples of the forms include plate shapes, cylindrical shapes, rod shapes, shapes of specific containers, etc.

After attaching the laminated sheet for firing to the adherend, it is preferable to use a device such as a squeegee to press the laminated sheet for firing from the protective sheet side in order to ensure secure adhesion.

(2) Step 2

In step 2, the protective sheet and the temporary adhesion layer are removed from the laminated sheet for firing (from which the release sheet has been removed) on the adherend. The method for removing the protective sheet and the temporary adhesion layer is not particularly limited. Usually, they can be peeled off.

In the case where the temporary adhesion layer is formed from water-soluble weak adhesive resins, after removing the protective sheet, water is added dropwise using a dropper to the exposed temporary adhesion layer. After the temporary adhesion layer is left to stand for about 10 to 60 seconds, the temporary adhesion layer can be removed by dissolution.

(3) Step 3

In step 3, the adherend having the heat-resistant base layer and combustible adhesive layer obtained in step 2 is fired.

The firing temperature and time can be suitably changed according to the composition and the like of the laminated sheet for firing having the identification part of the present invention. The firing temperature is, for example, usually 300 to 1,500° C., and preferably 400 to 1,200° C. Further, the firing time is, for example, usually 0.1 to 10,000 hours, and preferably 0.1 to 1,000 hours.

An adherend to which a label having the identification part (an identification label) is attached can be formed by the above steps 1 to 3. The thickness of the label having the identification part is about 1 to 30 μm.

When the identification label is thick, the identification label is likely to be strained during hot and cold cycles and when subjected to heat shocks such as rapid heating to a high temperature and rapid cooling from a high temperature, resulting in the occurrence of cracks and peeling. However, according to the production method of the present invention, an adherend to which a very thin identification label is attached can be formed, and it is therefore possible to prevent such cracks, peeling, etc.

The laminated sheet for firing having the identification part of the present invention can be directly attached to an adherend, has excellent heat resistance, and is free from cracks, bulges, and peeling during rapid temperature changes such as a rapid temperature increase and rapid water-cooling. Further, because the laminated sheet for firing of the present invention is also flexible to follow the change in shape of the adherend, it can be used not only in various fields that require heat resistance, but also in wide industrial fields, such as the food, machinery, and chemistry fields. The laminated sheet for firing of the present invention can be particularly used for process control and quality control, such as in the process of production and control of glass panels, the process of automobile glass production, and the process of ceramic sintering, where high heat resistance and the like are required.

### EXAMPLES

Hereinafter, the present invention is described in detail using Examples and Comparative Examples; however, the present invention is not limited to these examples. Note that “%” indicates “percentage by weight”.

### Production Examples 1 and 2

### Production of Heat-Resistant Ink Dispersion Paste

The raw materials were mixed in the proportions shown in Table 1, thereby producing heat-resistant ink dispersion pastes Nos. 1 and 2. The black pigment for firing and Tyranno Coat VN-100 in Table 1 are as shown below.

Black pigment for firing: mixed metal oxide pigment, Daipyroxide Black 9510, produced by Dainichiseika Color & Chemicals Mfg. Co., Ltd.
Tyranno Coat VN-100: product name, a resin composition comprising, as resin components, 50% of silicone resin (polyalkyl(methyl)phenylsiloxane straight silicone) and 50% of polytitanocarbosilane resin, produced by Ube Industries, Ltd.

TABLE 1

Production Example

| | 1 | 2 |
|---|---|---|
| Ink Dispersion Paste No. | 1 | 2 |
| Black pigment for firing | 25 | 25 |
| Tyranno Coat VN-100 | 20 | |
| Paraffin wax | 8 | 8 |
| Carnauba wax | 8 | 8 |
| Toluene | 39 | 39 |

(Parts by weight)

### Production Examples 3 to 5

### Production of Base Layer Coating Solution

The raw materials were mixed in the proportions shown in Table 2, thereby producing base layer coating solutions Nos. 1 to 3. Tyranno Coat VN-100 in Table 2 is the same as the one described in Production Example 1. TSR-116, dispersant, titanium oxide, and bismuth borate glass frit in Table 2 are as follows. TSR-116: silicone resin varnish (produced by Momentive Performance Materials Inc.)

Dispersant: DISPARLON DA705, produced by Kusumoto Chemicals, Ltd. Titanium oxide: average particle diameter of 0.4 μm
Bismuth borate glass frit: average particle diameter of 10 μm, boiling point of 450° C.

TABLE 2

| | Production | | |
|---|---|---|---|
| | Example | | |
| | 3 | 4 | 5 |
| Base Layer Coating Solution No. | 1 | 2 | 3 |
| Tyranno Coat VN-100 | 45 | | 45 |
| TSR-116 | | 45 | |
| Titanium oxide | 45 | 45 | 45 |
| Dispersant | 1 | 1 | 1 |
| Xylene | 9 | 9 | 9 |
| Bismuth borate glass frit | | | 3 |

(Parts by weight)

### Example 1

A peeling layer of a 4.5 μm PET film having a heat resistant layer on one side and the peeling layer on the other side was coated using a bar coater with the heat-resistant ink dispersion paste No. 1 obtained in Production Example 1 to a dry layer thickness of 3 μm, and the paste was dried for 1 minute at 100° C. using a hot air circulation oven (STPH-201, produced by ESPEC Corporation), thereby forming a heat-resistant thermal transfer ink sheet.

Using the above heat-resistant thermal transfer ink sheet, a bar code was printed in mirror writing by a thermal-transfer printer on a dextrin layer of a transfer paper for ceramics (SPA, Marushige Shiko Co. Ltd.) to which commercially available dextrin has been applied, thereby forming an identification part on the transfer paper.

Next, the transfer paper was coated using a bar coater with the base layer coating solution No. 1 obtained in Production Example 3 so as to cover the identification part to a dry layer thickness of 5 μm, and the solution was dried for 1 minute at 100° C. using a hot air circulation oven (STPH-201, produced by ESPEC Corporation), thereby forming a base sheet comprising a temporary adhesion layer and a heat-resistant base layer having the identification part.

At the same time, a peeling slip to which a silicone remover has been applied was coated with a mixture comprising 100 parts by weight of acrylic adhesive (COPONYL 5836, Nippon Synthetic Chemical Industry Co., Ltd.) and 1 part by weight of polyisocyanate (CORONATE L-55E, Nippon Polyurethane Industry Co., Ltd.) as a cross-linking agent to a dry layer thickness of 10 μm; and the mixture was dried for 1 minute at 100° C. using a hot air circulation oven (STPH-201, produced by ESPEC Corporation), thereby forming an adhesive sheet.

The acrylic adhesive layer of the adhesive sheet was adhered to the heat-resistant base layer of the base sheet, thereby preparing a laminated sheet for firing having an identification part.

### Example 2

A laminated sheet for firing having an identification part was prepared in the same manner as in Example 1, except that the base layer coating solution No. 2 obtained in Production Example 4 was used instead of the base layer coating solution No. 1 used in Example 1.

### Example 3

A laminated sheet for firing having an identification part was prepared in the same manner as in Example 1, except that the base layer coating solution No. 3 obtained in Production Example 5 was used instead of the base layer coating solution No. 1 used in Example 1.

### Example 4

A laminated sheet for firing having an identification part was prepared in the same manner as in Example 3, except that the heat-resistant ink dispersion paste No. 2 obtained in Production Example 2 was used instead of the heat-resistant ink dispersion paste No. 1 used in Example 3.

### Example 5

A peeling slip to which a silicone remover was applied was coated using a bar coater with the base layer coating solution No. 3 obtained in Production Example 5 to a dry layer thickness of 5 μm, and the solution was dried for 1 minute at 100° C. using a hot air circulation oven (STPH-201, produced by ESPEC Corporation), thereby preparing a base sheet.

Separately, a peeling slip to which a silicone remover was applied was coated using a bar coater with a mixture comprising 100 parts by weight of acrylic adhesive (COPONYL 5836, Nippon Synthetic Chemical Industry Co., Ltd.) and 1 part by weight of polyisocyanate (CORONATE L-55E, Nippon Polyurethane Industry Co., Ltd.) as a cross-linking agent to a dry layer thickness of 10 μm; and the mixture was dried for 1 minute at 100° C. using a hot air circulation oven (STPH-201, produced by ESPEC Corporation), thereby preparing an adhesive sheet.

The heat-resistant base layer of the base sheet was adhered to the acrylic adhesive layer of the adhesive sheet, and the peeling slip on the heat-resistant base layer was removed, thereby producing a base laminated sheet comprising a peeling slip, an acrylic adhesive layer, and a heat-resistant base layer.

Next, using the heat-resistant thermal transfer ink sheet prepared in Example 1, a bar code was printed by a thermal-transfer printer on the thus-obtained base laminated sheet, thereby preparing a base laminated sheet having an identification part.

At the same time, a PET film (38 μm) was coated using a bar coater with a mixture comprising 100 parts by weight of acrylic adhesive (COPONYL 5767, Nippon Synthetic Chemical Industry Co., Ltd.) and 2 parts by weight of polyisocyanate (CORONATE L-55E, Nippon Polyurethane Industry Co., Ltd.) as a cross-linking agent to a dry layer thickness of 10 μm; and the mixture was dried for 1 minute at 100° C. using a hot air circulation oven (STPH-201, produced by ESPEC Corporation), thereby preparing a PET film having an acrylic weak-adhesive layer.

The heat-resistant base layer of the base laminated sheet having an identification part (i.e., the side having the identification part) was adhered to the acrylic weak-adhesive layer of the PET film, thereby preparing a laminated sheet for firing having an identification part.

### Comparative Example 1

Aluminum foil (40 μm) was coated using a bar coater with the base layer coating solution No. 1 obtained in Production Example 3 to a dry layer thickness of 10 μm, and the solution was dried for 1 minute at 100° C. using a hot air circulation oven (STPH-201, produced by ESPEC Corporation).

Next, the other side of the aluminum foil (i.e., the side opposite to the side having the heat-resistant base layer) was coated using a bar coater with silicone adhesive to a dry layer thickness of 15 μm; the adhesive was dried for 1 minute at 100° C. using a hot air circulation oven (STPH-201, produced by ESPEC Corporation); and a fluorine-treated PET film as a separator to prevent adhesion was adhered to the adhesive side of the aluminum foil, thereby preparing a laminated sheet.

### Comparative Example 2

A peeling slip to which a silicone remover was applied was coated using a bar coater with the base layer coating solution No. 2 obtained in Production Example 4 to a dry layer thickness of 30 μm, and the solution was dried for 1 minute at 100° C. using a hot air circulation oven (STPH-201, produced by ESPEC Corporation), thereby preparing a base sheet.

Separately, a peeling slip to which a silicone remover was applied was coated using a bar coater with a mixture comprising 100 parts by weight of acrylic adhesive (COPONYL 5836, Nippon Synthetic Chemical Industry Co., Ltd.) and 1 part by weight of polyisocyanate (CORONATE L-55E, Nippon Polyurethane Industry Co., Ltd.) as a cross-linking agent to a dry layer thickness of 10 μm; and the mixture was dried for 1 minute at 100° C. using a hot air circulation oven (STPH-201, produced by ESPEC Corporation), thereby preparing an adhesive sheet.

The heat-resistant base layer of the base sheet was adhered to the acrylic adhesive layer of the adhesive sheet, and the peeling slip on the heat-resistant base layer was removed, thereby producing a base laminated sheet comprising a peeling slip, an acrylic adhesive layer, and a heat-resistant base layer.

Next, using the heat-resistant thermal transfer ink sheet prepared in Example 1, a bar code was printed by a thermal-transfer printer on the thus-obtained base laminated sheet, thereby preparing a base laminated sheet having an identification part.

Each laminated sheet for firing having an identification part obtained in Examples 1 to 5 and each sheet obtained in Comparative Examples 1 and 2 were tested by the following methods.

<Test Method>

Test 1

### (1) Test Plate Production Method

### (1-1) Laminated Sheets for Firing Having an Identification Part Prepared in Examples 1 to 4

The peeling slip of the laminated sheet for firing having an identification part was removed, and the laminated sheet for firing was attached to a SUS304 plate via the exposed acrylic adhesive layer. Subsequently, the sheet was securely adhered by pressure using a squeegee. Next, the transfer paper on the laminated sheet was dampened with water using a dropper and left to stand for 30 seconds to dissolve dextrin. Subsequently, the transfer paper on the uppermost surface was removed. A sheet having a bar code displayed thereon appeared on the SUS304 plate. The thus-obtained SUS304 plates to which the laminated sheets for firing having an identification part (prepared in Examples 1 to 4) were adhered were regarded as test plates 1 to 4.

### (1-2) Laminated Sheet for Firing Having an Identification Part Prepared in Example 5

The peeling slip of the laminated sheet for firing having an identification part was removed, and the laminated sheet for firing was attached to a SUS304 plate via the exposed acrylic adhesive. Subsequently, the sheet was securely adhered by pressure using a squeegee. Next, the PET film on the surface was peeled off, and a sheet having a bar code displayed thereon appeared on the SUS304 plate. Note that the acrylic weak-adhesive was removed with the PET film. The thus-obtained SUS304 plate to which the laminated sheet for firing having an identification part (prepared in Example 5) was adhered was regarded as test plate 5.

### (1-3) Laminated Sheet Obtained in Comparative Example 1

The PET separator on the laminated sheet was removed, and the laminated sheet was attached to a SUS304 plate via the exposed silicone adhesive. Subsequently, the surface was vertically pressed down using a silicone rubber for close adhesion. The thus-obtained SUS304 plate to which the laminated sheet obtained in Comparative Example 1 was adhered was regarded as test plate 6.

### (1-4) Base Laminated Sheet Having an Identification Part Prepared in Comparative Example 2

The peeling slip was removed from the base laminated sheet having an identification part, and the base layer having an identification layer was adhered to a SUS304 plate via the exposed acrylic adhesive. Subsequently, the surface was vertically pressed down using a silicone rubber for close adhesion. However, because the base layer was weak, it was broken when removing the peeling slip. Good attachment was therefore not achieved. This plate was regarded as test plate 7.

### (2) Appearance

The above-described test plates 1 to 7 were separately placed in ovens. The temperature was raised from room temperature to 600° C. at a rate of 10° C./minute, and maintained at 600° C. for 1 hour. One hour later, test plates 1 to 7 were removed from the ovens. After cooling by air, the appearance was visually evaluated according to the following evaluation criteria.

A: There are no creases or cracks. Good appearance.

B: There are creases, but no cracks.

C: There are cracks.

D: Cracking or peeling occurred, and the identification layer is unrecognizable.

### (3) Adhesion

The above-described test plates 1 to 7 were separately placed in ovens. The temperature was raised from room temperature to 600° C. at a rate of 10° C./minute, and test plates 1 to 7 were maintained at the temperature for 1 hour. One hour later, test plates 1 to 7 were removed from the ovens. After cooling by air, Sellotape (registered trademark) was firmly stuck to the test plates, and pulled off rapidly from one end for evaluation.

A: No peeling occurred.

B: Almost no peeling occurred, and the identification layer is recognizable.

C: Partial peeling occurred.

D: Peeling occurred, and the identification layer is unrecognizable.

Table 3 shows the results of evaluation of appearance and adhesion.

TABLE 3

| | Appearance | Adhesion |
|---|---|---|
| Example 1 | A | A |
| Example 2 | A | A |
| Example 3 | A | A |
| Example 4 | A | A |
| Example 5 | A | A |
| Comparative Example 1 | B | D |
| Comparative Example 2 | C | C |

Test 2

### (1) Appearance

Test plates 1 to 7 prepared by a method similar to that in Test 1 were separately placed in ovens each maintained at an internal temperature of 900° C., rapidly heated, and maintained at the temperature for 1 hour. One hour later, test plates 1 to 7 were removed from the ovens, placed in water, and rapidly cooled (rapid water-cooling). After rapid water-cooling, the appearance was visually evaluated according to the following evaluation criteria.

A: There are no creases or cracks. Good appearance.

B: There are creases, but no cracks.

D: There are cracks, and the identification layer is unrecognizable.

### (2) Adhesion

Test plates 1 to 5 prepared by a method similar to that in Test 1 were separately placed in ovens each maintained at an internal temperature of 900° C., rapidly heated, and maintained at the temperature for 1 hour. One hour later, test plates 1 to 5 were removed from the ovens, placed in water, and rapidly cooled (rapid water-cooling). After rapid water-cooling, Sellotape (registered trademark) was firmly stuck to the test plates, and pulled off rapidly from one end for evaluation.

A: No peeling occurred.

B: Almost no peeling occurred, and the identification layer is recognizable.

C: Partial peeling occurred, but the identification layer is recognizable.

D: The identification layer was peeled off.

### (3) Scratch Resistance

Test plates 1 to 5 prepared by a method similar to that in Test 1 were separately placed in ovens each maintained at an internal temperature of 900° C., rapidly heated, and maintained at the temperature for 1 hour. One hour later, test plates 1 to 5 were removed from the ovens, placed in water, and rapidly cooled (rapid water-cooling). After rapid water-cooling, the surface was scrubbed (about 200 g load) 10 times back and forth with a stainless steel brush (0.2 mm in diameter), and the scratch resistance was evaluated according to the following evaluation criteria.

A: There is no damage.

B: There is almost no damage, and the identification layer is not scraped.

C: There is some damage, but the identification layer is recognizable.

D: The surface is damaged, and the identification layer is unrecognizable.

Table 4 shows the results of evaluation of appearance, adhesion, and scratch resistance.

TABLE 4

| | | | Scratch |
|---|---|---|---|
| | Appearance | Adhesion | Resistance |
| Example 1 | A | A | B |
| Example 2 | C | B | C |
| Example 3 | A | A | A |
| Example 4 | A | B | A |
| Example 5 | A | A | A |
| Comparative Example 1 | D | Not tested | Not tested |
| Comparative Example 2 | D | Not tested | Not tested |

Test 3

### (1) Method for Producing Test Plates

In the method for producing test plates in Test 1, aluminum plates, silica glass plates, ceramics, and SUS304 tubes (outside diameter of 102 mm) were used instead of the SUS304 plates; and the laminated sheets for firing having an identification part, which were obtained in Examples 1 to 5, and the sheets obtained in Comparative Examples 1 and 2 were individually adhered to the outer surface of the above plates and SUS304 tubes.

### (2) Appearance

The thus-obtained test plates were placed separately in ovens each maintained at the temperatures shown in Table 5, and fired. After standing to cool, the appearance was evaluated according to the following evaluation criteria.

A: There are no creases or cracks. Good appearance.

B: There are creases, but no cracks.

D: Cracking or peeling occurred, and the identification layer is unrecognizable.

TABLE 5

| | | | | SUS304 tubes |
|---|---|---|---|---|
| | Aluminum | Silica | | 102 mm in |
| Adherend | Plate | Glass | Ceramics | diameter |
| Temperature | 500° C. × | 700° C. × | 800° C. × | 900° C. × |
| Conditions | 5 hrs | 2 hrs | 3 hrs | 2 hrs |
| Example 1 | A | A | A | A |
| Example 2 | A | A | A | B |
| Example 3 | A | A | A | A |
| Example 4 | A | A | A | A |
| Example 5 | A | A | A | A |
| Comparative | B | D | D | D |
| Example 2 | | | | |
| Comparative | D | D | D | D |
| Example 2 | | | | |

Examples 1 to 5 resulted in a good appearance on each adherend. Comparative Example 1 resulted in a good appearance on the aluminum plate; however, cracking and peeling occurred when fired at a temperature higher than the melting point of aluminum. Comparative Example 2 resulted in cracking on each adherend when placed into the ovens.

### REFERENCE SYMBOL LIST

1: Protective sheet
2: Temporary adhesion layer
3: Identification part
4: Heat-resistant base layer
5: Combustible adhesive layer
6: Release sheet

1. A laminated sheet for firing having an identification part, the laminated sheet comprising a protective sheet, a temporary adhesion layer, a heat-resistant base layer, a combustible adhesive layer, and a release sheet, which are laminated in this order;
the heat-resistant base layer having a thickness of 30 μm or less, comprising a silicone resin and an inorganic powder, and having the identification part, the identification part being formed from a heat-resistant ink containing an inorganic pigment.

2. The laminated sheet for firing according to claim 1, wherein the heat-resistant base layer further comprises a polymetallocarbosilane resin and/or a glass frit.

3. The laminated sheet for firing according to claim 1, wherein the heat-resistant ink further comprises at least one member selected from the group consisting of a silicone resin, a polymetallocarbosilane resin, and a glass frit.

4. A method for producing an adherend to which a label having an identification part is attached, the method comprising the steps of:
(1) removing the release sheet from the laminated sheet for firing having an identification part according to claim 1, and attaching, to an adherend, the laminated sheet for firing from which the release sheet has been removed;
(2) removing the protective sheet and the temporary adhesion layer from the laminated sheet for firing, from which the release sheet has been removed and which has been attached to the adherend; and
(3) firing the adherend having the heat-resistant base layer and combustible adhesive layer.

5. The method according to claim 4, wherein the adherend is a substrate selected from the group consisting of a metal substrate, a glass substrate, and a ceramic substrate.

6. The laminated sheet for firing according to claim 2, wherein the heat-resistant ink further comprises at least one member selected from the group consisting of a silicone resin, a polymetallocarbosilane resin, and a glass frit.
